(19) United States
(12) Patent Application Publication
(10) Pub. No.: US 2002/0042971 A1
(43) Pub. Date: Apr. 18, 2002

(54) Hinge torsion device

(76) Inventor: Chia Yu Liao, Taipei (TW)

Correspondence Address: Chia Yu Liao, 235 Chung - HO, Box 8-24, Taipei, TW

(21) Appl. No.: 09/963,747

(22) Filed: Sep. 27, 2001

(30) Foreign Application Priority Data
Oct. 13, 2000 (TW) 89219046

(51) Int. Cl. E05D 11/08

(52) U.S. Cl. 16/342

(57) ABSTRACT

A hinge torsion device having a tubular sleeve is disclosed. The hinge torsion device is suitable for electronic devices (such as notebook computers or PDAs). The hinge torsion device comprises a friction element, and a rotary shaft. The friction element is tightly and coaxially inserted into the sleeve, and the rotary shaft is pivotally installed to the friction element. The friction element has an axial hole for being pivotally installed with the rotary shaft. The axial hole is disposed eccentrically. The wall of the friction element has a slot axially arranged and penetrating the wall of the friction element. Thereby, the strength of the cross section of the friction element is enhanced.

### FIELD OF THE INVENTION

The present invention relates to hinges, and particularly to a hinge torsion device having a preferable ability to resisting torsional force, and the hinge torsion device is suitable to be used in pivot elements utilized in connecting the screens of notebook computers or PDAs to the mainframe thereof.

### BACKGROUND OF THE INVENTION

Hinges are widely used in notebook computers or PDAs (personal digital assistants) to connect two adjacent elements, for example, using a hinge to connect a screen of a notebook computer to a mainframe thereo. The hinge must provide proper torsional force for providing the screen and the mainframe to rotate freely.

In prior hinge torsion device, a torsion unit is used for adjusting torsional forces. The torsion unit is formed by a retaining seat, a rotary seat and an elastic element. One end of the rotary seat has a pivotal shaft. A distal end of the pivotal seat has a tapered hole. One end of the tapered hole is a threaded hole. One outer side of the pivotal shaft is formed with a slot. The elastic element is formed by winding a piece-like material. One side thereof has a slot. The elastic element covers an outer portion of the pivot shaft and then the two are placed in the retainer. The taper hole of the pivot shaft is engaged with an adjusting stud. The adjusting stud has a taper end. The adjusting stud is screwed into the threaded hole at the end of the taper hole by the threaded post at the tapered distal end of the adjusting stud. Thereby, the position of the adjusting stud in the threaded hole is adjustable. Thus, the tapered end of the adjusting stud will eject the pivot shaft having a slot so that the elastic element expands outwards. Thereby, by the friction force between the elastic element and the retaining seat, the torsional unit may provide a proper torsional force.

In above prior art, a trosional force is provided by the elastic force of the elastic element and the adjusting stud. However, above elastic element is formed by winding a uniform piece-like material. Furthermore, one side thereof has a slot. Therefore, it can be expanded by the adjusting stud. This will cause the elastic element to become weak. Therefore, it easily breaks.

### SUMMARY OF THE INVENTION

Accordingly, the primary object of the present invention is to provide a hinge torsion device, wherein the hinge has a preferred strength.

Another object of the present invention is to provide a hinge torsion device, wherein the structure of the hinge is simple and can be assembled easily.

To achieve above objects, the present invention provides a hinge torsion device having a tubular sleeve. The hinge torsion device is suitable for electronic devices (such as notebook computers or PDAs). The hinge torsion device comprises a friction element, and a rotary shaft. The friction element is tightly and coaxially inserted into the sleeve, and the rotary shaft is pivotally installed to the friction element. The friction element has an axial hole for being pivotally installed with the rotary shaft. The axial hole is disposed eccentrically. The wall of the friction element has a slot axially arranged and penetrating the wall of the friction element. Thereby, the strength of the cross section of the friction element is enhanced.

The various objects and advantages of the present invention will be more readily understood from the following detailed description when read in conjunction with the appended drawing.

### BRIEF DESCRIPTION OF THE DRAWINGS

FIG. 1 is a structural exploded view of the present invention.

FIG. 2 is a structural exploded view of another embodiment of the present invention.

FIG. 3 is a structural assembled view of FIG. 2.

FIG. 4 is a partial structural view of the present invention.

### DETAILED DESCRIPTION OF THE PREFERRED EMBODIMENTS

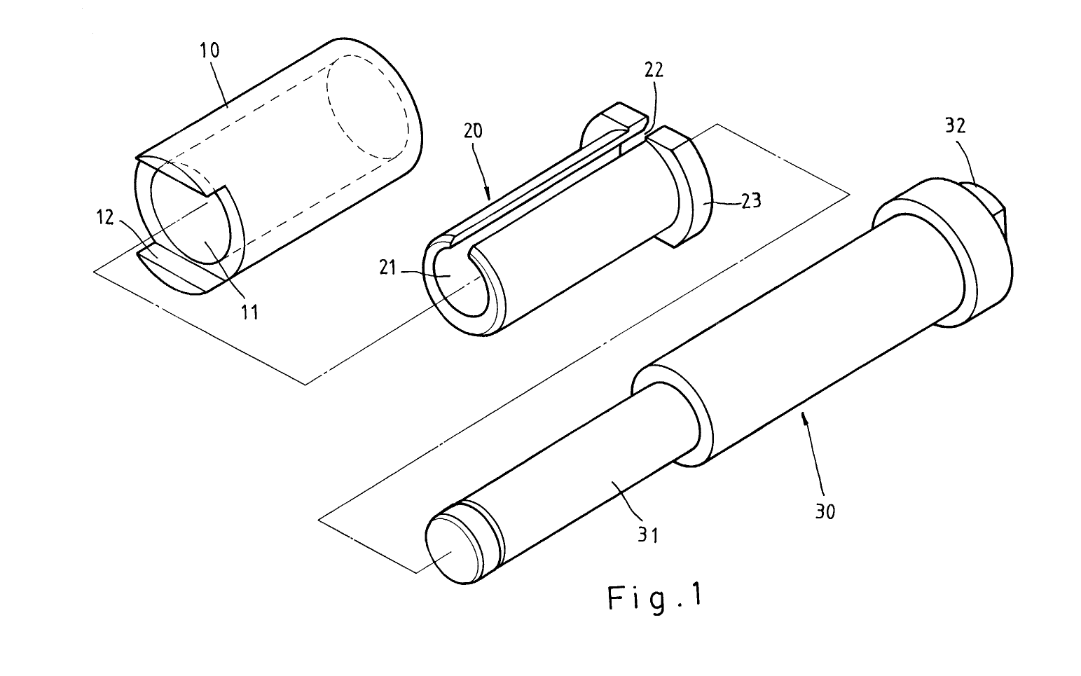

Referring to FIGS. 1, the hinge torsion device of the present invention includes the following components.

A tubular sleeve 10 has a through hole 11 penetrating the axial center thereof.

A friction element 20 is tightly engaged into the through hole 11 of the sleeve 10. Thus the friction element 20 is motionlessly fixed to the sleeve 10. The friction element 20 is a hollow tubular element and has a penetrating axial hole 21 which is disposed eccentrically.

A rotary shaft 30 has at least one coupling section 31. The coupling section 31 can be engaged in the axial hole 21 of the friction element 20. By the friction force between the coupling section 31 and the axial hole 21 of the friction element 20, a proper resisting force is formed between the rotary shaft 30 and the friction element 20. As a result, as the rotary shaft 30 rotates with respect to the friction element 20, a proper resisting force for resisting torsional force will induce.

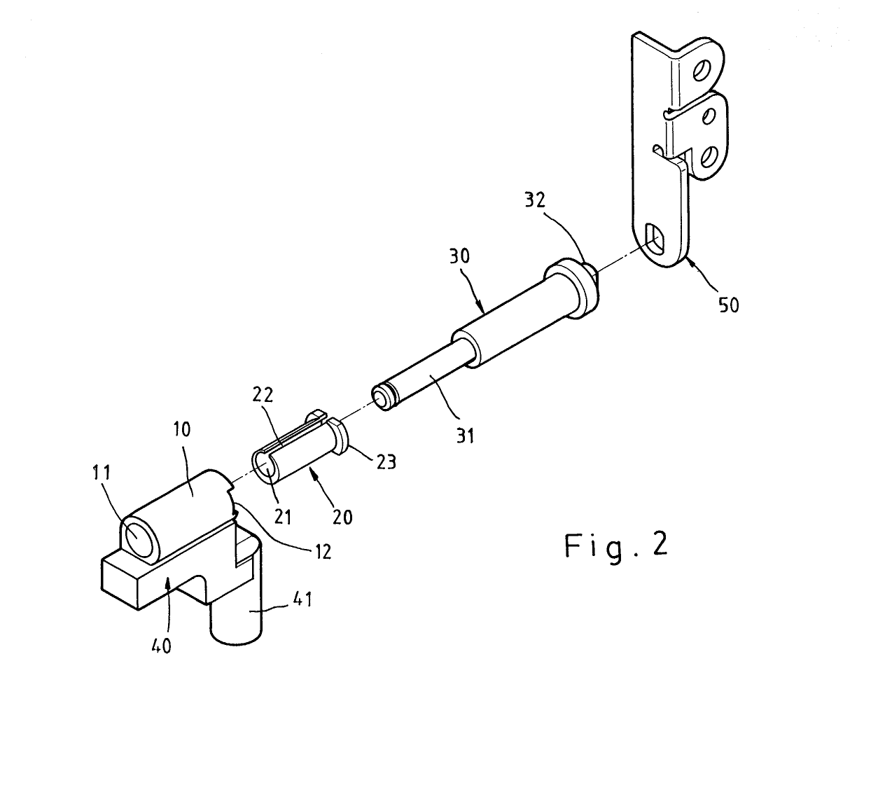

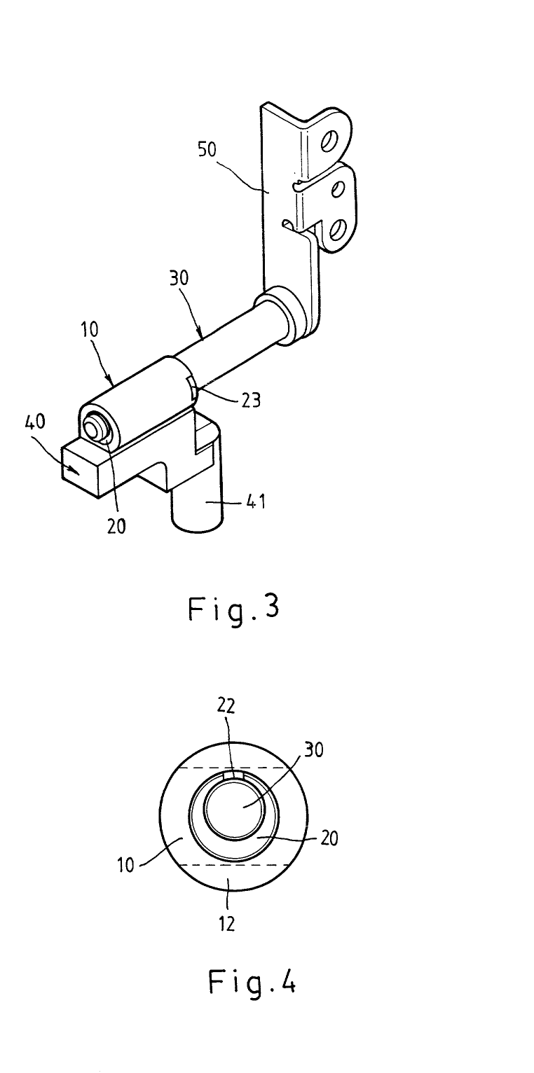

In general, as the present invention is used in a notebook computer, the sleeve 10 is fixed to the mainframe of a notebook computer and the rotary shaft 30 is fixed to the display (not shown) of a notebook computer. For example, referring to FIGS. 2 and 3, another embodiment of the present invention is illustrated. The sleeve 10 is fixed to a retainer 40, or is integrally with the retainer 40. Then the combined structure is further combined with the mainframe of a notebook computer through a binding unit, for example, a threaded post 41 of the retainer 40. In another aspect, another end of the rotary shaft 30 is firmly secured to a binding plate 50. For example, one end of the sleeve 10 is installed with a projection 32. Then this projection 32 is connected to the binding plate 50 by riveting. Then, the display of the notebook computer is mounted to the binding plate 50.

Referring to FIG. 1, the feature of the present invention is the friction element 20. The friction element 20 may cause the rotary shaft 30 to be pivotally installed to the axial hole 21 eccentrically. The wall of the friction element 20 has an axial slot 22 penetrating the friction element 20. Therefore, the cross section of the friction element 20 has a shape like a horse's hoof (referring to FIG. 4). Therefore, the strength of the structure of the friction element in the cross sectional view can be enhanced and has a preferred deformation-proof ability.

The inner diameter of the through hole 11 of the slot sleeve 10 is slightly smaller than the outer diameter of the friction element 20. Therefore, the friction element 20 is inserted into the through hole 11 of the sleeve 10, because of the slot 22 of the friction element 20, the coupling section 31 of the rotary shaft 30 will be clamped in the axial hole 21 of the friction element 20 due to the sleeve 10. Therefore, a proper friction resisting force is generated between the rotary shaft 30 and the friction element 20. Therefore, as the rotary shaft 30 rotates with respect to the friction element 20, a proper torsion-resisting force is generated.

Preferably, the friction element 20 is fixed to the sleeve 10 by a retainer. For example, this retainer includes a positioning groove 12 at one end of the sleeve 10. Furthermore, it may be a positioning unit 12 as illustrated in FIG. 1, or be other irregular shapes. One end of the friction element 20 has a hat portion 23 which can be embedded into the positioning unit 12. The hat portion 23 protrudes axially from the friction element 20.

Referring to FIG. 1, the position unit is a straight slot passing through the opening of the sleeve.

Therefore, it is known from above description that by the friction element 20 and the axial hole 21 disposed eccentrically, the friction element 20 is deformable. Moreover, the cross section of the friction element 20 has a preferable structure with a preferable strength.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A hinge torsion device having a tubular sleeve comprising a friction element, and a rotary shaft, wherein the friction element is tightly and coaxially inserted into the sleeve, and the rotary shaft is pivotally installed to the friction element; characterized in that:
the friction element has an axial hole for being pivotally installed with the rotary shaft; the axial hole is disposed eccentrically; the wall of the friction element has a slot axially arranged and penetrating a wall of the friction element; thereby, the strength of a cross section of the friction element is enhanced.

2. The hinge torsion device as claimed in claim 1, further comprising a retainer for tightly fixing the friction element to the sleeve.

3. The hinge torsion device as claimed in claim 2, wherein the retainer is a position unit at one end of the sleeve and a hat portion at one end of the friction element, wherein the position unit is engagable with the hat portion.

4. The hinge torsion device as claimed in claim 3, wherein the position unit is a straight slot passing through the opening of the sleeve.
